(19) United States
(12) Patent Application Publication
(10) Pub. No.: US 2026/0170586 A1
(43) Pub. Date: Jun. 18, 2026

(54) ENHANCED SHUTTLE DEPLOYMENT

(71) Applicant: Ford Global Technologies, LLC, Dearborn, MI (US)

(72) Inventor: Keith Weston, Canton, MI (US)

(21) Appl. No.: 18/980,545

(22) Filed: Dec. 13, 2024

(51) Int. Cl. G06Q 50/40; H04W 4/029

(52) U.S. Cl. CPC G06Q 50/40; H04W 4/029

(57) ABSTRACT

A method for enhanced shuttle pickup management includes sending shuttle user details about a plurality of shuttle users to a shuttle pickup management server. The details include at least one of, an estimated time of arrival (ETA) of the shuttle users at a designated pickup area, details regarding luggage of the plurality of users, an itinerary of the shuttle users, or a location of vehicles of the shuttle users. The shuttle pickup management server executes a machine learning optimization algorithm optimize at least one characteristic that reflects shuttle fleet key performance indicators. The shuttle pickup management server then deploys at least one shuttle vehicle of a plurality of shuttle vehicles to the designated pickup area based on the machine learning optimization algorithm, such that shuttle deployment optimizes the at least one characteristic.

### TECHNICAL FIELD

Aspects of the disclosure generally relate to enhanced shuttle deployment using details about shuttle users and a shuttle management server.

### BACKGROUND

The statements in this section merely provide background information related to the present disclosure and may not constitute prior art.

Vehicle-to-everything (V2X) allows vehicles to exchange information with other vehicles, as well as with infrastructure, pedestrians, networks, and other devices. Vehicle-to-infrastructure (V2I) communication enables applications to facilitate and speed up communication or transactions between vehicles and infrastructure. In a vehicle telematics system, a telematics control unit (TCU) may be used for various remote-control services, such as over the air (OTA) software download, eCall, and turn-by-turn navigation. Similarly, users desiring to ride on a vehicle may have mobile devices that enable them to communicate with vehicles via communications networks.

### SUMMARY

This section provides a general summary of the disclosure and is not a comprehensive disclosure of its full scope or all of its features.

In one form, the present disclosure is directed to a method for enhanced shuttle pickup management that includes sending shuttle user details about a plurality of shuttle users to a shuttle pickup management server. The details include at least one of, an estimated time of arrival (ETA) of the shuttle users at a designated pickup area, details regarding luggage of the plurality of users, an itinerary of the shuttle users, or a location of vehicles of the shuttle users. The shuttle pickup management server executes a machine learning optimization algorithm optimize at least one characteristic that reflects shuttle fleet key performance indicators. The shuttle pickup management server then deploys at least one shuttle vehicle of a plurality of shuttle vehicles to the designated pickup area based on the machine learning optimization algorithm, such that shuttle deployment optimizes the at least one characteristic.

In one form, the present disclosure is directed to a system for enhanced shuttle pickup management. The system is configured to maintain shuttle vehicle details and shuttle user details including at least an identified location of a plurality of shuttle users. The shuttle vehicle details and the shuttle user details are relevant to movement via shuttle vehicle of the shuttle users to their next destination. The system includes at least one location identification device configured to identify the location of the plurality of shuttle users, as well as a shuttle pickup management server configured to execute a machine learning optimization algorithm to optimize at least one characteristic. The shuttle management server does so using the shuttle vehicle details and the shuttle user details, then deploys at least one of a plurality of shuttle vehicles, calculates a shuttle estimated time of arrival (ETA), and calculates a designated shuttle pickup location. The systems also includes an application on a shuttle user mobile device configured to display the shuttle ETA and the designated shuttle pickup location of at least one of the plurality of shuttle users.

In one form, the present disclosure is directed to a non-transitory computer-readable medium comprising instructions for shuttle pickup management that, when executed by a shuttle pickup management server, cause the shuttle pickup management server to perform operations including to maintain shuttle vehicle details, weather details and shuttle user details including at least an identified location of a plurality of shuttle users. The shuttle vehicle details, weather details and the shuttle user details are relevant to movement via shuttle vehicle of the shuttle users to their next destination. The instructions, when executed by a shuttle pickup management server, further cause the shuttle pickup management server to execute a machine learning optimization algorithm to optimize at least one characteristic. The instructions, when executed by a shuttle pickup management server, further cause the shuttle pickup management server to deploy at least one of a plurality of shuttle vehicles according to the machine learning optimization algorithm, calculate a shuttle estimated time of arrival (ETA) and a designated shuttle pickup location, and send the shuttle ETA as well as the designated shuttle pickup location of at least one of the plurality of shuttle users to an application on a shuttle user mobile device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 illustrates an example system for implementing an enhanced shuttle deployment system.

FIG. 2 illustrates an example process for optimal deployment of a plurality of shuttle vehicles for shuttle user pickup.

FIG. 3 illustrates an example process for determining and updating shuttle user estimated time of arrival (ETA).

FIG. 4 illustrates an example system for tracking shuttle user location to support the process of determining and updating shuttle user ETA.

FIG. 5 illustrates an example system for tracking shuttle user luggage status and location to support the process of determining and updating shuttle user ETA.

FIG. 6 illustrates an example system for learning shuttle user behavior to support the process of determining and updating shuttle user ETA.

FIG. 7A is an example of a route to a time-bounded next step in an itinerary of a shuttle user, where the time-bounded next step is a restaurant reservation.

FIG. 7B is an example of an alternate route to a time-bounded next step in an itinerary of a shuttle user, where the time-bounded next step is a restaurant reservation and the alternate route avoids expected traffic delays.

FIG. 7C is an example of a route to a time-bounded next step in an itinerary of a shuttle user, where the time-bounded next step is a set-time restaurant reservation but the shuttle user needs to stop at an intermediate location.

FIG. 7D is an example of a route to a time-bounded next step in an itinerary of a shuttle user, where the time-bounded next step is public transportation with a known departure time.

FIG. 8 illustrates an example computing device implementing an enhanced shuttle deployment system.

The drawings described herein are for illustration purposes only and are not intended to limit the scope of the present disclosure in any way.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The illustrative examples provide an opportunity to optimize shuttle deployment by smart dispatching using details about shuttle users and processed, for example, by a shuttle management server. Shuttle users may opt-in to a system that expedites more efficient pick up by transmitting shuttle user details to a shuttle management server. Shuttle users may arrive at a shuttle pickup point at an estimated time of arrival (ETA). ETA may be computed using the shuttle user data that was transmitted to the shuttle management server. Shuttle user details may include shuttle user location, shuttle user itinerary, shuttle user luggage status, shuttle user typical behavior, shuttle user previously recorded parked vehicle location, as well as other information not listed here. This information, taken together, can estimate shuttle users' ETA in arrival designated loading areas, as well as identify special requirements of shuttle users that may require one vehicle over another.

As discussed herein, a shuttle vehicle (or shuttle) is a mode of transportation designed to move shuttle users between specified locations, typically in a shared or on-demand capacity. These vehicles may be managed as part of a broader shuttle system and may vary in size, capacity, and capabilities to accommodate different use cases, such as short commutes, airport transfers, or last-mile connectivity. A shuttle user refers to an individual or entity utilizing a shuttle vehicle for transportation.

Shuttles may be deployed using a shuttle management server, which may be configured to optimize any of a number of variables relevant to the deployment of shuttle vehicles, including, but not limited to: wait time for the shuttle users; likelihood that at least one of the shuttle users will be able to make a connection; overall travel time of the shuttle users; cost of shuttle fleet operations, or other variables relevant to the deployment of shuttle vehicles not listed here. The shuttle management server can optimize deployment using various pieces of information, including, but not limited to, shuttle user details, shuttle user ETA, shuttle details (i.e. shuttle location, capacity, capabilities and current destination), traffic information, detected vehicles and people at the pickup area, and available assigned parking at the pickup area, to name a few.

The optimization performed by the shuttle management server provides an opportunity to automatically select and dispatch appropriate vehicles, in terms of both size and capabilities. The optimization can result in significant resource savings, as smaller vehicles can be used when needed, as well as significant overhead savings, as the fleet can be right-sized and does not require buying the largest and most capable vehicles for every use-case in the fleet. Further, when no passengers are present, vehicles are not deployed, saving both resources and wear-and-tear on the vehicles. Further aspects of the disclosure are discussed in detail herein.

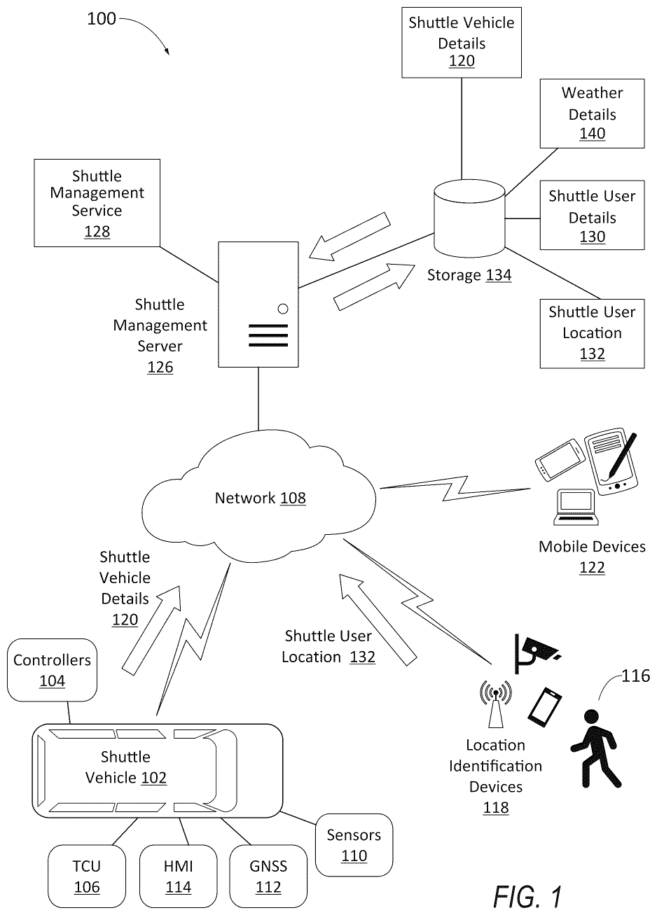

FIG. 1 shows an illustrative example of a shuttle fleet dispatch and shuttle user pickup system 100. The shuttle user pickup system 100 includes a shuttle vehicle 102 having various controllers 104. These controllers 104 include a telematics control unit (TCU) 106 to allow the shuttle vehicle 102 to communicate with remote devices over a communications network 108. These controllers 104 may also include a global navigation satellite system (GNSS) controller 112 and a human machine interface (HMI) controller 114. The shuttle user pickup system 100 also includes a shuttle management server 126 configured to communicate over the communications network 108 with the shuttle vehicles 102 as well as location identification devices 118 which could be used to determine shuttle user location 132. The shuttle management server 126 may execute a shuttle management service 128 configured to optimize deployment of shuttle vehicles 102 based on shuttle vehicle details 120 (information about shuttle vehicles 102) and shuttle user details 130 (information about shuttle users 116) as well as, in some examples, weather details 140. In some cases, the shuttle vehicle details 120, shuttle user details 130 and/or the weather details 140 may be relevant to movement via shuttle vehicle 102 of the shuttle users 116 to their next destination. As additional non-limiting examples, shuttle user details 130 could include various information about shuttle users 116, such as an itinerary of the shuttle users 116; parked vehicle location; typical behaviors; Transportation Security Administration (TSA) Precheck or “known traveler” status; preferences of the shuttle user 116 regarding sufficient time between portions of the itinerary; loyalty status of the shuttle user 116; seat position of the shuttle user 116 on the vehicle prior to riding on shuttle vehicle 102; shuttle user location 132; ETA at a designated pickup area 452, dimensions of luggage; weight of luggage; or a special handling characteristic of the luggage of the shuttle user 116. In some non-limiting examples, a special handling characteristic may be that the luggage is designated as fragile; requires climate control; or require specialized equipment for loading. In additional non-limiting examples, a shuttle vehicle 102 may be equipped with sensors that determine shuttle user details 130 (e.g., scales to determine luggage weight, cameras to identify luggage dimensions or special handling characteristics).

Alternatively or as well, vehicles that shuttle user 116 have used directly prior to riding on shuttle vehicle 102 (e.g. a personal vehicle of a shuttle user 116, an airplane, a train, a bus, a boat) may similarly be equipped with sensors that determine shuttle user details 130, which can be communicated to the shuttle management service 128 over the communications network 108 to better optimize deployment of shuttle vehicles 102. In further examples, weather details 140 (e.g. whether it is raining, snowing, cold or hot) can be incorporated into optimization of system 100 through better estimation of shuttle vehicle 102 travel times and/or an improved understanding user preferences regarding wait times in a given weather scenario (e.g. waiting in an unsheltered area when it is cold and snowy or unbearably hot is less preferred then when it is sunny and mild). In some examples, weather details 140 could include precipitation, temperature, wind conditions, or humidity.

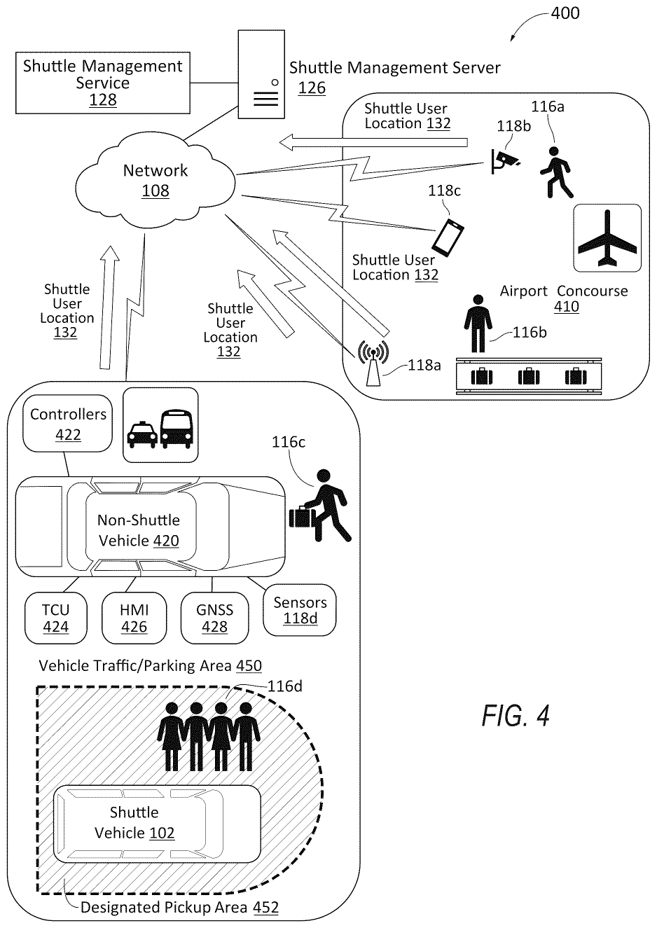

In some non-limiting examples, shuttle user location 132 may be determined by location identification devices 118, including, but not limited to, those depicted in FIG. 4: Wi-Fi access points 118a; stationary cameras 118b; mobile devices 122 of the shuttle users 116; and non-shuttle vehicle sensors 118d, as well as those not shown, e.g., prepositioned radio frequency identification (RFID) transponders, other mobile devices 122, RFID luggage tags, shuttle vehicle sensors 110 or any other location identification device 118 configured to locate a shuttle user 116. In another non-limiting example, vehicles of the shuttle users 116 are partially autonomous, and their parking location is a predefined staging area to which the vehicles of the shuttle users 116 have redeployed.

The shuttle vehicle 102 may be any of the following: an automobile, bus, van, crossover utility vehicle (CUV), sport utility vehicle (SUV), truck, recreational vehicle (RV), boat, plane or other mobile machine for transporting people or goods. In many cases, the shuttle vehicle 102 may be a battery electric vehicle (BEV) powered by a traction battery and one or more electric motors. As a further possibility, the shuttle vehicle 102 may be a hybrid electric vehicle powered by both an engine, a traction battery, and one or more electric motors. Hybrid shuttle vehicles 102 may come in various forms, such as a series hybrid electric vehicle, a parallel hybrid electrical vehicle, or a parallel/series hybrid electric vehicle. As the type and configuration of shuttle vehicle 102 may vary, the capabilities of the shuttle vehicle 102 may correspondingly vary.

As some possibilities, shuttle vehicles 102 may have different capabilities with respect to passenger capacity, towing ability and capacity, and storage volume. As some additional possibilities, shuttle vehicles 102 could be equipped to specially accommodate people with particular needs, i.e. a shuttle vehicle 102 may have special loading equipment for shuttle users 116 confined to a wheelchair, may have special equipment designed to support blind shuttle users 116, may be equipped with car seats for shuttle users 116 with young children, or may be equipped with special office equipment for workers who need to conduct a video teleconference en route to their next destination. For title, inventory, and other purposes, shuttle vehicles 102 may be associated with unique identifiers, such as vehicle identification numbers (VINs) e.g. as defined by the International Organization for Standardization (ISO) 3779 and ISO 8030, globally unique identifiers (GUIDs), customer or fleet accounts, etc. Note, in some examples, the additional time needed to specially accommodate people with particular needs will be factored into the overall shuttle deployment optimization by the shuttle management service 128, both in cases where the particular needs require a specially equipped shuttle vehicle 102 or could be handled by a standard shuttle vehicle 102 without special equipment.

The shuttle vehicle 102 may include a plurality of controllers 104 configured to perform and manage various shuttle vehicle 102 functions under the power of the vehicle battery and/or drivetrain. As some non-limiting vehicle controller 104 examples: a powertrain controller 104 may be configured to provide control of engine operating components (e.g., idle control components, fuel delivery components, emissions control components, etc.) and for monitoring status of such engine operating components (e.g., status of engine codes); a body controller 104 may be configured to manage various power control functions such as exterior lighting, interior lighting, keyless entry, remote start, and point of access status verification (e.g., closure status of the hood, doors and/or trunk of the shuttle vehicle 102); a radio transceiver controller 104 may be configured to communicate with key fobs, mobile devices 122, or other shuttle vehicle 102 devices; an autonomous controller 104 may be configured to provide commands to control the powertrain, steering, or other aspects of the shuttle vehicle 102; a climate control management controller 104 may be configured to provide control of heating and cooling system components (e.g., compressor clutch, blower fan, temperature sensors, etc.); a GNSS controller 104 may be configured to provide shuttle vehicle 102 location information; and an HMI controller 104 may be configured to receive user input via various buttons or other controls, as well as provide shuttle vehicle 102 status information to a driver, such as fuel level information, engine operating temperature information, and current location of the shuttle vehicle 102. The shuttle vehicle 102 may also be configured to power other devices external to the shuttle vehicle 102 using the shuttle vehicle 102 battery and/or drivetrain.

The TCU 106 is a controller 104 of the shuttle vehicle 102 that may be utilized for communication over the communications network 108. In an example, TCU 106 may be configured to provide telematics services to the shuttle vehicle 102. These services may include, as some non-limiting possibilities, navigation, turn-by-turn directions, health reports of the shuttle vehicle 102, local business search, accident reporting, and hands-free calling. The TCU 106 may include network hardware configured to facilitate communication between the shuttle vehicle 102 and other devices of the shuttle user pickup system 100. For example, the TCU 106 may include or otherwise access a cellular modem configured to facilitate communication with the communications network 108. The communications network 108 may include one or more interconnected communication networks such as the Internet, a cable television distribution network, a satellite link network, a local area network, a cellular vehicle to everything (CV2X) network, a Dedicated Short-Range Communications (DSRC) network and a telephone network, as some non-limiting examples.

The communications network 108 may provide communications services, such as packet-switched network services (e.g., Internet access, voice over internet protocol (VOIP) communication services), to devices connected to the communications network 108. For instance, the TCU 106 may access the communications network 108 via connection to one or more cellular towers. In another example, the TCU 106 may access the communications network 108 via a Wi-Fi connection.

A vehicle bus (not shown) may include various methods of communication available between the controllers 104, as well as between the TCU 106 and the vehicle controllers 104. As some non-limiting examples, a vehicle bus may include one or more of a controller area network (CAN), an Ethernet network, and a media-oriented system transfer (MOST) network.

Sensors 110 may include various hardware of the shuttle vehicle 102 that is used to collect information about its surroundings and status. As some non-limiting examples, the sensors 110 may include one or more of cameras (e.g., advanced driver assistance system (ADAS) cameras), ultrasonic transceivers, radio detection and ranging (RADAR) systems, and/or light detection and ranging (LIDAR) systems.

The GNSS controller 112 may be configured to provide information indicative of the current location of the shuttle vehicle 102. In an example, the GNSS controller 112 may be responsible for receiving signals from a GNSS constellation of satellites. This may allow the GNSS controller 112 to receive time information as well as for determining a precise location of the shuttle vehicle 102. The location determined by the GNSS controller 112 may be used for various tasks such as navigation or other location-based services.

The HMI controller 114 may be configured to provide an interface through which the shuttle vehicle 102 occupants may interact with the shuttle vehicle 102. The interface may include a touchscreen display, voice commands, and physical controls such as buttons and knobs. The HMI controller 114 may be configured to receive user input via the various buttons or other controls, as well as provide status information to a driver, such as fuel level information, engine operating temperature information, and current location of the shuttle vehicle 102. The HMI controller 114 may be configured to provide information to various displays within the shuttle vehicle 102, such as a center stack touchscreen, a gauge cluster screen, etc. The HMI controller 114 may accordingly allow the shuttle vehicle 102 occupants to access and control various systems such as navigation, entertainment, and climate control.

In one non-limiting example, shuttle vehicle details 120 could include one or more of: a current location of the shuttle vehicle 102, vehicle capacity of the shuttle vehicle 102 (both for personnel, cargo, and overall weight), vehicle capabilities of the shuttle vehicle 102 (e.g., ability to accommodate a shuttle user 116 in a wheelchair), and a current assigned task of the shuttle vehicle 102. In a non-limiting example, the shuttle vehicle details 120 may include the make, model, and/or features installed to the shuttle vehicle 102 at manufacture and/or aftermarket. In yet another non-limiting example, the shuttle vehicle details 120 may indicate a VIN or other identifier of the shuttle vehicle 102, which may be used to access shuttle vehicle details 120 with respect to the configuration and/or capabilities of the shuttle vehicle 102. In another example, the shuttle vehicle details 120 includes information with respect to the configuration or other features of the shuttle vehicle 102. For example, the shuttle vehicle details 120 may indicate the software versions installed to the controllers 104 of the shuttle.

The shuttle management server 126 may be an example of a networked computing device that is accessible to the shuttle vehicles 102, location identification devices 118, mobile devices 122 and/or other devices over the communications network 108. The shuttle management server 126 may be configured to execute the shuttle management service 128 to perform the operations of the shuttle management server 126 discussed herein. The shuttle vehicle 102 may send data from its sensors 110 over the communications network 108 to the shuttle management server 126. The shuttle vehicle 102 may send shuttle vehicle details 120 over the communications network 108 to the shuttle management server 126.

The shuttle management server 126 may maintain shuttle vehicle details 120 as well as shuttle user details 130 in a storage medium 134. For example, the shuttle management server 126 may receive from the communications network 108 information indicative of the quantity of shuttle vehicles 102 in a geographic area. In another example, the shuttle management server 126 may receive shuttle vehicle details 120 from the communications network 108 indicative of the locations of the shuttle vehicles 102. This information may, for instance, be based on a home location database of the communications network 108 that maintains information indicative of which cells are connected to the TCUs 106 of which shuttle vehicles 102. In another example, the shuttle vehicles 102 may report their locations to the shuttle management server 126, e.g., by using an GNSS controller 104 of the shuttle vehicle 102 to identify the vehicle location and sending that information by the TCU 106 over the communications network 108 to the shuttle management server 126.

The mobile devices 122 may be any of various types of portable computing device, such as cellular phones, tablet computers, smart watches, laptop computers, portable music players, or other devices having processing and communications capabilities. The mobile device 122 may include one or more processors configured to execute computer instructions, and a storage medium on which the computer-executable instructions and/or data may be maintained. The mobile devices 122 may be configured to connect to the TCU 106 or other controllers 104 of the shuttle vehicle 102 to provide communications services to the shuttle vehicle 102. The mobile devices 122 may be equipped with an application that a shuttle user 116 may use to reserve a seat on a shuttle vehicle 102. The application on the mobile device 122 may communicate with the shuttle management service 128 to request the ride, but also may communicate shuttle user details 130 to optimize deployment of the shuttle vehicles 102. In some non-limiting examples, the shuttle user details 130 could include information such as the shuttle user 116 itinerary, luggage characteristics, party size, parked vehicle location and the like. In one example, the shuttle user 116 may consent (for example, via the application) to sharing in real time the shuttle user location 132 or historical typical behavior of the shuttle user 116 with the shuttle management service 128, which would incorporate that information into the shuttle vehicle 102 deployment optimization.

Shuttle vehicles 102 may be used to provide feedback to and improve optimization of the shuttle management service 128. As the shuttle management service 128 continuously runs, individual shuttle vehicles 102 could report back to the shuttle management service 128 regarding the efficacy of ongoing operations. In some non-limiting examples, this may include observations about ongoing traffic patterns, expected number of shuttle users 402 at the designated pickup area 452 compared to actual number of shuttle users 116 at the designated pickup area 452, whether expected characteristics of luggage 502 of the shuttle users 116 aligns with actual characteristics of the luggage 502 of the shuttle users 116, or whether shuttle users 116 expected itinerary aligns with their observed travel. Shuttle vehicles 102 may be identified and grouped to obtain statistically relevant samples from different market populations. These groups consider variations in climate, thermal temperatures from previous records, brands and series of shuttle vehicles 102, power levels, and installation characteristics. Each relevant population may run operational modes, diagnostics, and regression testing, reporting successes, failures, and abnormal operations. Thresholds may be predetermined (e.g., empirically, via machine learning, etc.) to understand if the standard deviation for the population exceeds acceptable limits or if any defects occur. Results are reported and flagged by the shuttle management service 128 if any proper function fails. Regardless of the specific feedback, the shuttle management service 128 may use this information to improve performance in subsequent iterations of shuttle deployment.

It should be noted that the primary example for shuttle usage is in an airport. However, it should be clear to anyone skilled in the art that a similar system could be applied, in whole or in part, in a variety of analogous contexts, i.e. train station, ferry terminal, cruise terminal, bus station, space port, or even at a hotel or downtown area.

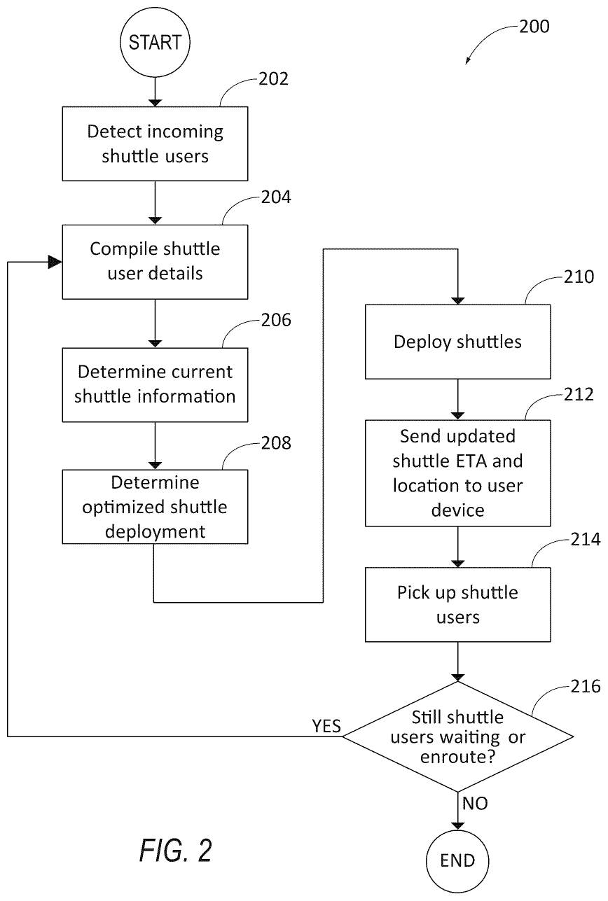

FIG. 2 illustrates an example iterative process 200 for performing analysis and ongoing deployment of shuttle vehicles 102 to optimize at least one characteristic that reflects fleet key performance indicators. In some non-limiting examples, the optimized characteristic includes at least one of: a wait time for the shuttle users 116; an aggregate likelihood that the shuttle users 116 will be able to make a connection; an overall travel time of the shuttle users 116; or a cost of shuttle fleet operations. In some examples, the ongoing deployment of shuttle vehicles 102 optimizes at least two characteristics, and the at least two characteristics are weighted based dynamically assessed relative value (e.g., at some times a cost of shuttle fleet may be valued more highly, at some times an overall travel time of the shuttle users 116 may be valued more highly). In one example, the process 200 may be performed by the shuttle vehicle 102, the location identification devices 118, the shuttle user mobile devices 122 and shuttle management server 126, in communication over the communications network 108.

At operation 202, incoming shuttle users 116 are detected. In one example, the detection of the incoming shuttle users 116 can be initiated through a request from the application on a mobile device 122 of the shuttle users 116 to the shuttle management service 128. In another example, the detection of the incoming shuttle users 116 could be initiated by a location identification device 118 correlated with itinerary of shuttle users 116 that have a pre-arranged reservation on the shuttle management service 128.

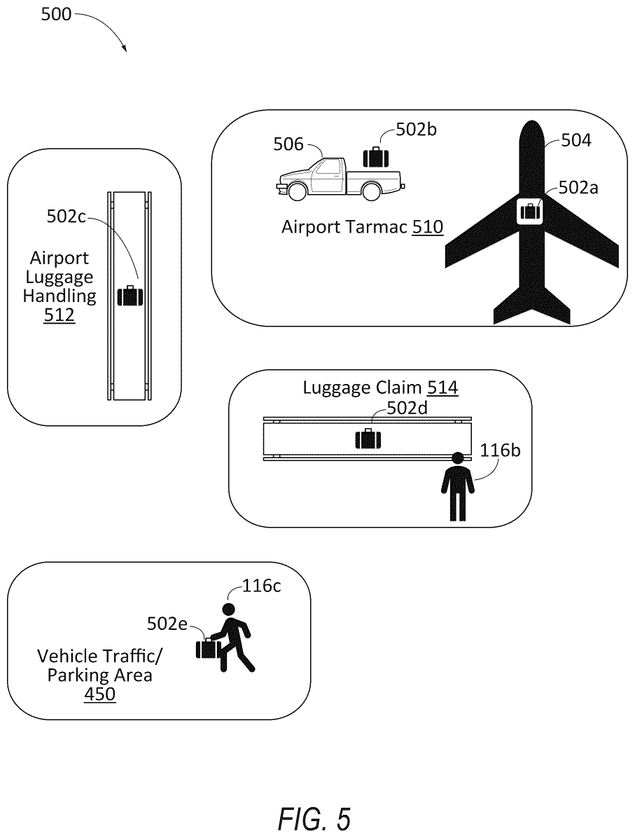

At operation 204, the shuttle management service 128 receives and compiles shuttle user details 130. In some non-limiting examples, the shuttle user details 130 may include shuttle user location 132, itinerary of the shuttle user 116, luggage 502 status of the shuttle user 116, typical behavior of the shuttle user 116, ETA of the shuttle user 116 at a designated pickup area 452 and parked vehicle location of the shuttle user 116. Note that a system of determining shuttle user location 132 is described in further detail with respect to location identification examples 400 in FIG. 4. Note as well that luggage 502 status of the shuttle user 116 may have been determined by the shuttle management server 126, as discussed in further detail with respect to luggage tracking examples 500 in FIG. 5.

At operation 206, the shuttle management service 128 receives and compiles shuttle vehicle details 120. In an example, the shuttle management service 128 may query the available shuttle fleet for the current details of a plurality of shuttle vehicles 102, including in one example current location, current assigned task, current capacity utilization (e.g., number of utilized seats and/or utilized cargo capacity), and/or current repair status of the shuttle vehicles 102. In another example, the shuttle management service 128 incorporates maintained shuttle vehicle details 120 held in the storage medium 134 of the shuttle management server 126, including, but not limited to: the make, model, and/or features installed to the shuttle vehicle 102 at manufacture and/or aftermarket; a VIN or other identifier of the shuttle vehicle 102, which may be used to access shuttle vehicle details 120 with respect to the configuration and/or capabilities of the shuttle vehicle 102; information with respect to the configuration or other features of the shuttle vehicle 102 or the software versions installed to the controllers 104 of the shuttle.

At operation 208, the shuttle management service 128 determines an optimized deployment for shuttle vehicles 102. In one non-limiting example, the shuttle management service 128 uses an optimization algorithm to determine the optimized deployment for shuttle vehicle. In another non-limiting example, deployment may be optimized based on one characteristic or multiple characteristics, including, but not limited to: wait time of the shuttle users 116; aggregate travel time of shuttle users 116; overall cost of shuttle fleet operations; or an aggregate likelihood that the shuttle users 116 will be able to make a connection. In some examples, the shuttle management service 128 may use the observed past outcomes as training data and a supervised machine learning algorithm (e.g., Gaussian Process Regression (GPR) supervised machine learning algorithm) to generate a trained machine learning module to better optimize shuttle vehicle 102 deployment. As an example, the observed past outcomes may include, given a particular deployment of shuttle vehicles 102 and a certain set of shuttle vehicle details 120, shuttle user details 130 and/or weather details 140, the resulting wait times of shuttle users 116 aggregate travel time of shuttle users 116; overall cost of shuttle fleet operations; or an aggregate likelihood that the shuttle users 116 will be able to make a connection. Responsive to generating the trained machine learning module, the shuttle management service 128 may store the trained machine learning module to better optimize shuttle vehicle 102 deployment in a storage medium 134. In other examples, the shuttle management service 128 may use a foundational machine learning model (e.g., Claude, ChatGPT, llama, etc.) that is prompted to optimize shuttle vehicle deployment.

At operation 210, the shuttle management service 128 deploys shuttles in line with the optimized shuttle deployment determined at operation 208. In one example non-limiting example, the shuttle management service 128 alerts the driver of a plurality of shuttle vehicles 102 of an assignment aligned with the optimized shuttle deployment and provides an optimized route to carry out each step of the assignment e.g. via an HMI provided by the HMI controller 114. In another non-limiting example, the shuttle vehicles 102 are autonomous and shuttle management service 128 instructs the autonomous controller 104 of the autonomous shuttle vehicles 102 to drive an optimized rout to carry out an assignment aligned with the optimized shuttle deployment.

At operation 212, the shuttle management service 128 determines an ETA for the shuttle vehicle 102 arrival (e.g., at the designated pickup area 452 as depicted in FIG. 4) based on the deployment plan as well as historic traffic patterns and sends an updated shuttle vehicle 102 ETA to the respective mobile devices 122 of the shuttle users 116.

At operation 214, the shuttle vehicles 102 pick up the shuttle users 116. In some examples, current capacity utilization of the shuttle vehicle 102 is updated and sent, for example, by the shuttle vehicle 102 to the to the shuttle management service 128 for further refinement of the system optimization.

At operation 216, the shuttle management service 128 determines whether, following the pickup, there remain shuttle users 116 who are waiting for a ride or who are enroute to a designated pickup area 452. If there are, control returns to operation 204 to optimize shuttle vehicle 102 deployment in an ongoing manner. If there are not, the process 200 ends.

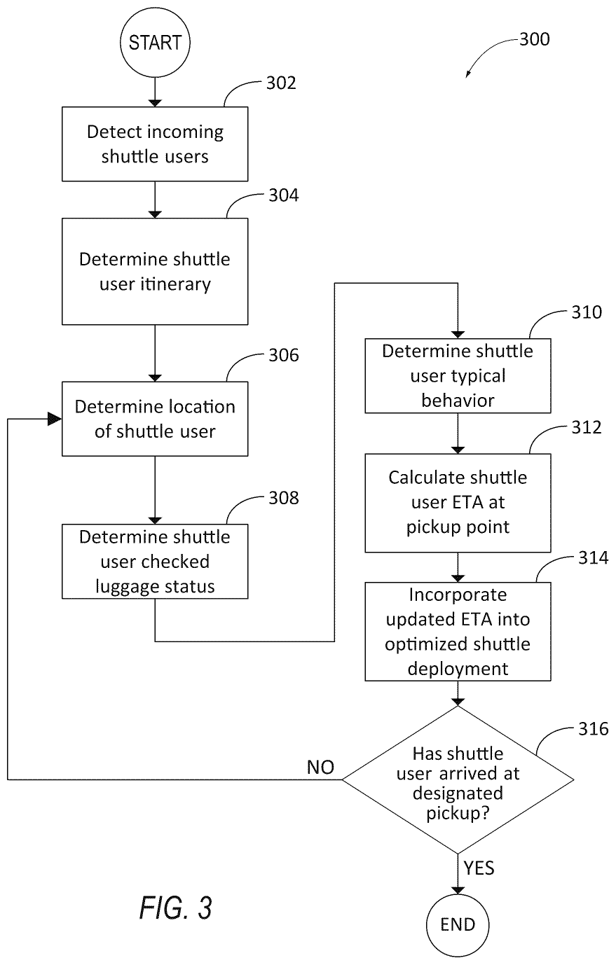

FIG. 3 illustrates an example process 300 for shuttle management service 128 calculating and iteratively updating shuttle user 116 ETA to better optimize shuttle vehicle 102 deployment. A number of factors may be relevant to shuttle user ETA. In some non-limiting examples, shuttle user 116 ETA is calculated by using at least one of: Shuttle user 116 itinerary; shuttle user 116 checked luggage status; shuttle user location 132; or shuttle user 116 typical behavior. In one example, as with the process 200, the process 300 may be performed by the shuttle vehicle 102, the location identification devices 118, the shuttle user mobile devices 122 and shuttle management server 126, in communication over the communications network 108.

At operation 302, as in operation 202, incoming shuttle users 116 are detected. In one example, this can be initiated through a request, from a rideshare application executed by the mobile device 122 of the shuttle user 116, to the shuttle management service 128. In another example, the detection of the incoming shuttle users 116 could be initiated by detection of a shuttle user 116 by a location identification device 118 being correlated with itinerary of shuttle users 116 that have a pre-arranged reservation on the shuttle management service 128.

At operation 304, the shuttle management service 128 determines the itinerary of the incoming shuttle user 116. In one example, this could be achieved by directly inputting the itinerary into the rideshare application on the mobile device 122 which is sent by the rideshare application to the shuttle management service 128. In another example, the determination of the itinerary could also be achieved, with appropriate permission by the shuttle user 116, by cross-referencing data from other functions on the mobile device 122, such as data collected by mobile applications of the relevant airline or public transportation scheduled immediately prior to the required shuttle vehicle 102 pickup. In a third example, the user itinerary could be discerned by cross-referencing a third-party travel aggregation application on the mobile device 122.

At operation 306, the shuttle management service 128 determines the shuttle user location 132. Note that an approach to determining shuttle user location 132 is discussed in further detail with respect to the location identification examples 400 in FIG. 4. However, in some non-limiting examples, the shuttle user location 132 may be determined by location identification devices 118, including, but not limited to, those depicted in FIG. 4, which include: Wi-Fi access points 118a; stationary cameras 118b; shuttle users' mobile devices 122; and non-shuttle vehicle sensors 118d, as well as those not shown, e.g., prepositioned RFID transponders, other mobile devices, RFID luggage tags, shuttle vehicle sensors 110 or another location identification device 118 configured to locate a shuttle user.

At operation 308, the shuttle management service 128 determines the checked luggage status of the shuttle users 116. Note as well that luggage status of the shuttle user 116 may have been determined by the shuttle management server 126, as discussed in further detail with respect to the luggage tracking examples 500 in FIG. 5.

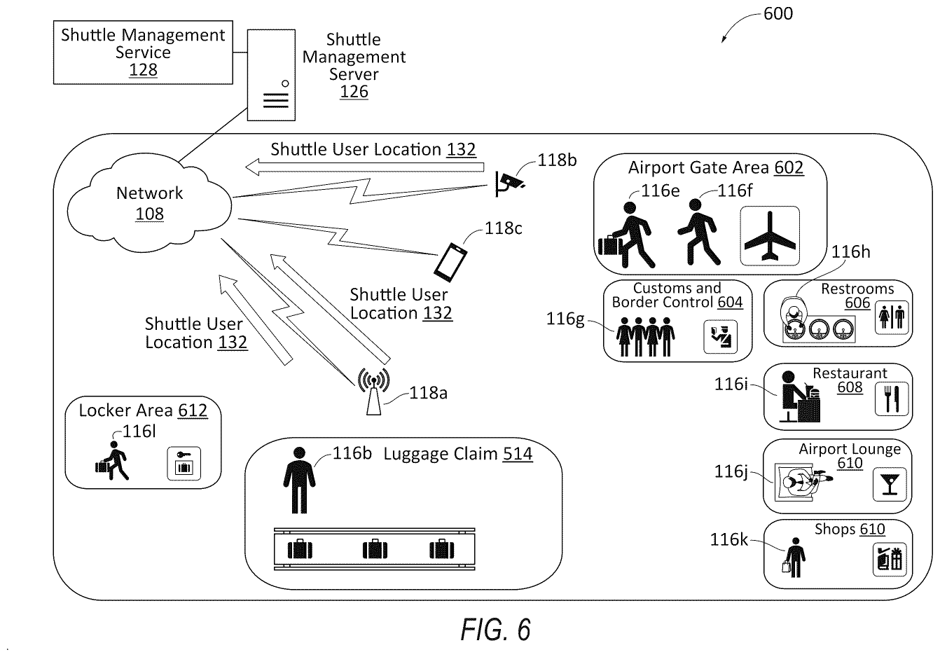

At operation 310, the shuttle management service 128 determines the checked typical behavior of the shuttle users 116. Note as well that shuttle user 116 typical behavior may have been determined by the shuttle management server 126, as discussed in further detail with respect to behavior analysis examples 600 in FIG. 6.

At operation 312, the results of operations 304, 306, 306, 308 and 310 are analyzed to help more accurately predict the ETA of the shuttle user 116. In some examples, the shuttle management service 128 may use the observed past outcomes as training data and a supervised machine learning algorithm (e.g., GPR supervised machine learning algorithm) to generate a trained machine learning module to more accurately predict the ETA of the shuttle user. As an example, the observed past outcomes may include, given a particular shuttle user location 132, a checked luggage status of the shuttle user 116, or a typical behavior of the shuttle user 116, the resulting actual time of arrival of the shuttle user 116. In one example, the shuttle user 116 itinerary is used as a starting point for an ETA using average travel times between the arrival gate and the designated pickup area 452. In a further example, the location of the shuttle user 116 is identified to assess whether the shuttle user 116 is ahead of or behind schedule, which further aids in refining the ETA. In a third example, the luggage status of the shuttle user 116 is assessed to better understand whether the shuttle users 116 will have to wait for their baggage at baggage claim or can proceed directly to the designated pickup area 452. In another non-limiting example, typical behavior of the shuttle users 116 is incorporated into an ETA prediction algorithm, so that if a shuttle user 116 regularly makes stops on the way out of the airport (i.e. at a restroom 606 or an airport lounge 610) it is considered when calculating shuttle user 116 ETA. Responsive to generating the trained machine learning module for shuttle user ETA, the shuttle management service 128 may store the trained machine learning module more accurately predict the ETA of the shuttle user 116 in a storage medium 134. In other examples, the shuttle management service 128 may also use a foundational machine learning model (e.g., as noted above) that is prompted more accurately predict the ETA of the shuttle user 116.

At operation 314, the refined ETA is incorporated into the optimized shuttle vehicle 102 deployment by the shuttle management service 128. As the ETA for each of the shuttle users 116 is refined to improve accuracy, the shuttle management service 128 adjusts how various shuttle vehicles 102 are managed to optimize the overall system deployment.

At operation 316, the shuttle management service 128 determines whether the shuttle user 116 has arrived at the designated pickup area 452. If he/she has not arrived, control returns to operation 306 to further refine and update the ETA of the shuttle user 116. If the shuttle user 116 has arrived, then the process 300 ends.

FIG. 4 shows a series of illustrative location identification examples 400 where a plurality of location identification devices 118 work together in the instance where the shuttle users 116 are traveling through a location (in one non-limiting example, an airport concourse 410) en route to a designated pickup area 452 for a shuttle vehicle 102. Note, this is used to feed information into operations 204 and 306 in processes 200 and 300 respectively. In the first example, a shuttle user 116a without established characteristics proceeds from the arrival gate through the airport concourse 410. Shuttle user location 132 is identified by various location identification devices 118, including but not limited to Wi-Fi access points 118a, stationary cameras 118b, and user mobile devices 118c, and transmitted to the shuttle management server 126 via the communications network 108. Based on identified movement through the concourse en route to the designated pickup area 452, characteristics of the unclassified shuttle user 116a are further refined to better estimate the ETA of the shuttle user 116a. Note, the location identification devices 118 are depicted in FIG. 4 as being inside the airport concourse 410, but the location identification devices 118 could be placed in any location that allows for tracking of the locations of the shuttle users 116.

In a second example, a shuttle user 116b that is waiting for his or her checked luggage is similarly having his or her shuttle user location 132 identified by various location identification devices 118. In addition, his or her luggage status, as determined by the system shuttle user pickup system 100 in the luggage tracking examples 500 of FIG. 5, will be considered when calculating his or her ETA once it is understood that he or she is waiting for luggage.

In a third example, a shuttle user 116 that has already received his or her checked luggage, e.g., shuttle user 116c, is similarly having his or her shuttle user location 132 identified by various location identification devices 118. Specifically, as the shuttle user 116c enters a vehicle traffic/parking area 450, his or her location may be identified by the non-shuttle vehicle sensors 118d on a non-shuttle vehicle 420 that has opted-in to the location identification system. Note, such a non-shuttle vehicle 420 has various controllers 422 parallel in function to those in the shuttle vehicles 102 depicted in FIG. 1, but not subject to management by the shuttle management service 128. These controllers 422 include a TCU 424 to allow the non-shuttle vehicle 420 to communicate with remote devices over a communications network 108 (shown in FIG. 1). These controllers 422 may also include a GNSS controller 428 and a HMI controller 426. These non-shuttle vehicle sensors 118d, spread throughout the vehicle traffic/parking area 450, are able to identify the location of the shuttle user 116 with checked luggage about to arrive in the designated pickup area 452 and thus update the ETA in the moments leading up to the actual arrival. Of note, the designated pickup area 452 could be a parking space pre-assigned by the shuttle management service 128. However, in some examples it could be dynamically assigned by the shuttle management service 128 based on traffic patterns around the vehicle traffic/parking area 450, detected vehicles parked in potential designated pickup areas 452, size of the shuttle vehicle 102 compared to available parking, or any other conceivable consideration. In some examples, the designated pickup area 452, could be sent to an application on the mobile device 122 of the shuttle user 116.

In another location identification example 400, a shuttle user 116d that has already arrived in the designated pickup area 452, could have his or her location identified by any of the aforementioned location identification devices 118. In addition, the shuttle user location 132 could be identified by the shuttle vehicle sensors 110, which could confirm that the expected number of shuttle users 116 are in the designated pickup area 452. If the number of shuttle users 116d that have already arrived in the designated pickup area 452 exceeds the capacity of the shuttle vehicle 102, the shuttle vehicle 102 may update the shuttle management service 128.

FIG. 5 shows a series of illustrative luggage tracking examples 500 in which luggage 502 of shuttle users 116 is tracked from the point where it arrives at the airport in the cargo hold of an airplane 504 to the point where it is retrieved and carried by a shuttle user 116 that has already received his or her checked luggage, e.g. the shuttle user 116c, into the vehicle traffic/parking area 450. Note, this is used to feed information into operations 204 and 308 in processes 200 and 300 respectively. Luggage 502 may be tracked in a number of ways, including through the use of location identification devices 118, but also including specific luggage tracking solution, for example internal airline luggage management systems or RFID luggage tags. Note, in some examples, the checked luggage 502 status may be tracked and maintained by the airline and may be communicated to the shuttle management service 128 over a communications network 108. In the initial example, the airplane 504 is on a tarmac 510 with luggage 502a that is still in the cargo hold. Location identification devices 118 internal to the cargo hold (e.g., luggage RFID tags) that detect the luggage 502a in the cargo hold may update the checked luggage status to the shuttle management service 128.

From there, the luggage is taken off the plane and loaded onto ground support equipment 506 en route to an airport luggage handling area 512. Luggage 502b on the ground support equipment 506 en route to the airport luggage handling area 512 may update the checked luggage status to the shuttle management service 128. Once unloaded, luggage 502c in the airport luggage handling area 512 may be tracked as it moves en route to luggage claim area 514, and likewise may update the checked luggage status to the shuttle management service 128.

Luggage 502d that has arrived at luggage claim may update the checked luggage status to the shuttle management service 128. Subsequently or simultaneously, the luggage 502 is then retrieved by a shuttle user 116b that is waiting for his or her checked luggage. Luggage 502e that has been claimed may still be used to enhance ETA, in this case by better identifying the location of a shuttle user 116c that has already received his or her checked luggage as he/she moves through the vehicle traffic/parking area 450, en route to the designated pickup area 452.

FIG. 6 shows a series of illustrative behavior analysis examples 600 in which shuttle user 116 typical behavior is observed, recorded, learned, and transmitted to the shuttle management service 128. Note, this is used to feed information into operations 204 and 310 in processes 200 and 300 respectively. As in FIG. 4 with location identification examples 400, several location identification systems work together in the instance where the shuttle users 116 are traveling through a location en route to a shuttle vehicle 102 designated pickup area 452. Similar to location identification examples 400, shuttle user location 132 is identified by various location identification devices 118, including but not limited to Wi-Fi access points 118a, stationary cameras 118b, and user mobile devices 118c. In contrast to the location identification examples 400 of FIG. 4, the behavior analysis examples 600 of FIG. 6 consider past behavior of the shuttle users 116 to additionally refine the ETA of the shuttle user 116. In some examples, shuttle user 116 can manually input shuttle user 116 typical behavior in the application on the mobile device 122 of the shuttle user 116.

In the first example, a shuttle user 116e that typically has only carry-on luggage proceeds from an airport gate area 602 for arrivals directly through the airport concourse 410 to the designated pickup area 452, bypassing the luggage claim area 514. Shuttle management service 128 will calculate an initial ETA for the shuttle users 116 which reflects the typical behavior of the shuttle user 116 of going directly from the airport gate area 602 to the designated pickup area 452 for catching the shuttle vehicle 102. In another example, a shuttle user 116f that typically has checked luggage that is observed in the airport gate area 602 will be further analyzed to anticipate typical behavior.

In yet more non-limiting illustrative examples, after leaving the gate area and prior to arriving at the shuttle vehicle 102 designated pickup area 452: Shuttle users 116g may be required to go through customs and border control 604, with resulting expected delays to ETA; shuttle user 116h may typically stop at the restroom 606; shuttle user 116i may typically choose to eat at a restaurant 608; airport lounge member shuttle user 116j may typically stop at an airport lounge 610; shuttle user 116k may typically shop in the airport terminal; shuttle user 116b may typically go directly to the luggage claim area 514 to wait for his or her luggage 502; and shuttle user 116l may typically drop his or her luggage off in a luggage locker at a luggage locker area 612.

It can be noted that any of the additional examples outlined in FIG. 6, while outlined in the context of learned typical behavior as an input to operation 310, could be used as inputs to observed behavior at operation 306 to better refine user ETA. Moreover, as observed shuttle user location 132, current luggage status or other actual shuttle user details 130 (e.g., itinerary) are transmitted to the shuttle management service 128, assumptions based on typical behavior are either confirmed or contradicted, with resulting adjustments to the ETA of the shuttle user 116.

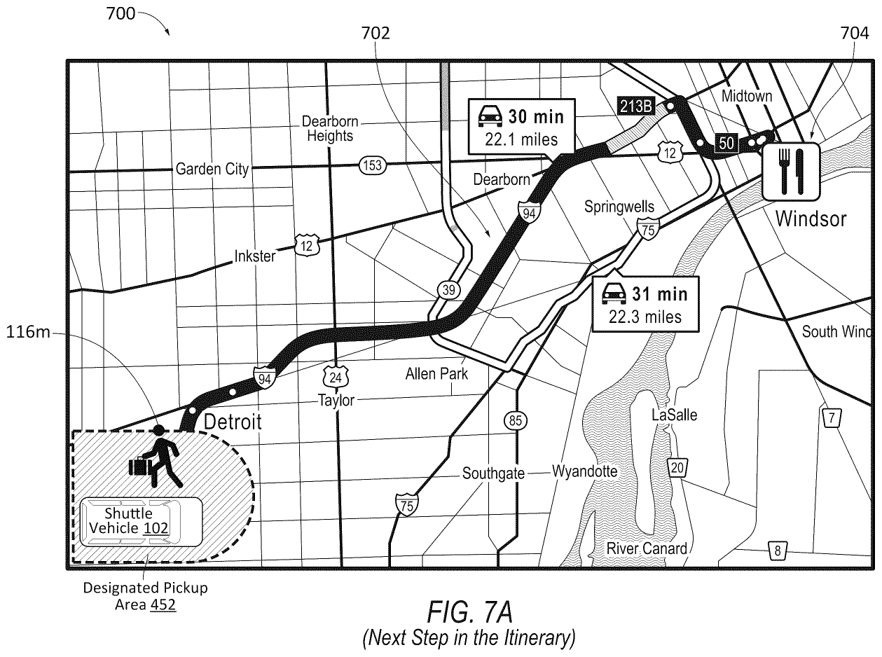

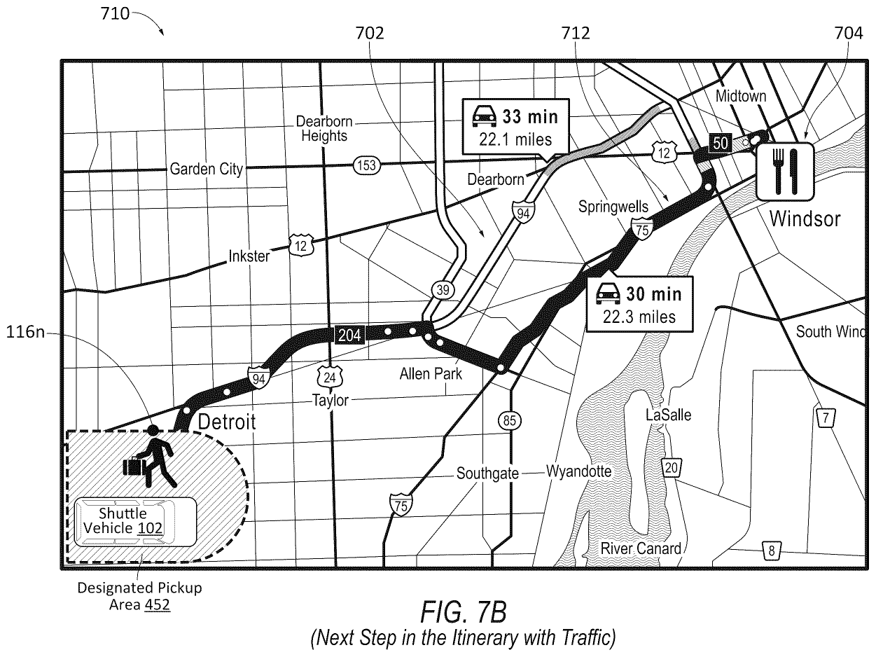

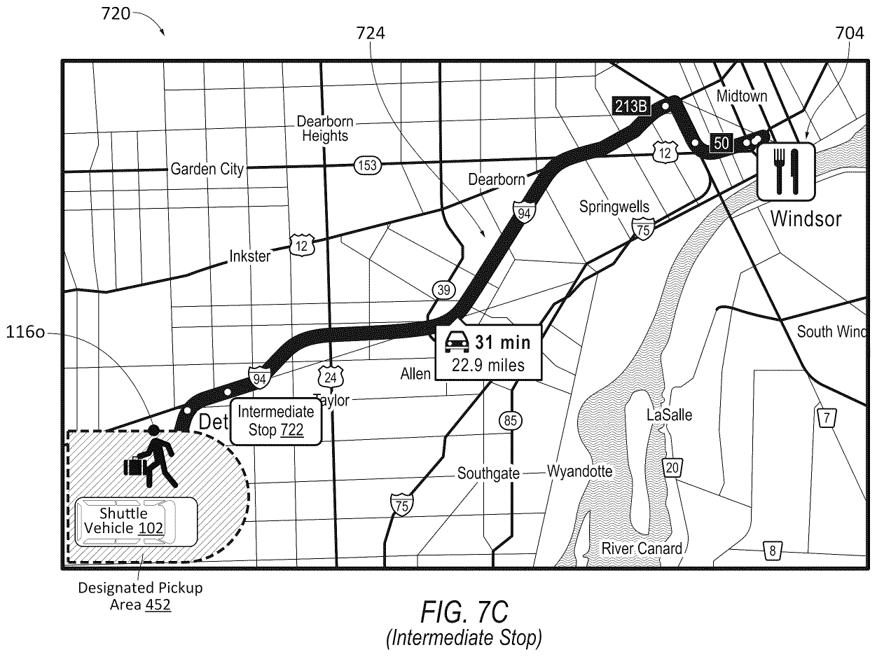

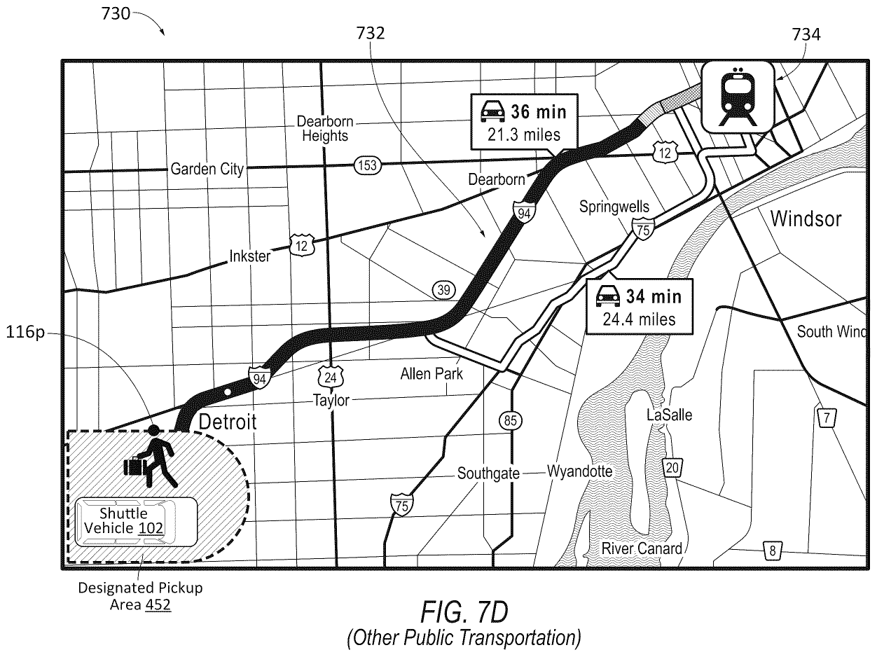

FIGS. 7A-D show a series of illustrative examples that can be used to help calculate the likelihood that a shuttle user 116 will be able to make a time-sensitive connection in his or her itinerary. In all cases, the shuttle management service 128 will take into account the current time and the scheduled time of the next stop when calculating that shuttle user 116m will be likely to arrive on time.

In FIG. 7A, shuttle user 116m has a time-sensitive dinner reservation at restaurant 704 soon after being picked up by a shuttle vehicle 102 at the designated pickup area 452. In this example, the shuttle management service 128 takes into account an estimated 30 minute travel time via route 702 based on real time navigation map 700 when calculating the likelihood that shuttle user 116m will be arrive on time.

In FIG. 7B, shuttle user 116n has a time-sensitive dinner reservation at restaurant 704 soon after being picked up by a shuttle vehicle 102 at the designated pickup area 452. In this example, the shuttle management service 128 takes into account additional traffic based on real time navigation map 710 compared to that shown real time navigation map 700 and takes alternate route 712 instead of route 702 to avoid the additional traffic. The shuttle management service 128 then takes into account the estimated 30 minute travel time on the alternate route 712 based on real time navigation map 710 when calculating the likelihood that shuttle user 116n will be arrive on time.

In FIG. 7C, shuttle user 1160 has a time-sensitive dinner reservation at restaurant 704 soon after being picked up by a shuttle vehicle 102 at the designated pickup area 452 and also needs to pick up his vehicle at intermediate stop 722 (i.e. an airport parking lot). In this example, shown on navigation map 720, to calculate the likelihood that shuttle user 1160 will be arrive on time, the shuttle management service 128 takes into account the time that shuttle vehicle 102 will take to arrive at intermediate stop 722, the time it will take shuttle user 1160 to transfer from shuttle vehicle 102 to his or her vehicle, the time it takes to move onward from the intermediate stop 722, and the time it takes to from intermediate stop 722 to restaurant 704 via route 724.

In FIG. 7D, soon after being picked up by a shuttle vehicle 102 at the designated pickup area 452, shuttle user 116p has a time-sensitive ticket to take a different form of public transportation (i.e. a train) from has a public transportation station 734 (i.e. a train station). In this example, the shuttle management service 128 takes into account an estimated 36 minute travel time via route 732 based on real time navigation map 730 when calculating the likelihood that shuttle user 116p will be arrive on time. In addition, the shuttle management service 128 may receive real time arrival and departure updates from the public transportation management organization (i.e. via a website or a direct feed information feed) and adjust the likelihood that shuttle user 116p arrive on time based on the updated arrival and departure information.

Note that shuttle users 116a-p are defined by certain characteristics. However, shuttle users 116 may also have characteristics that are not explicitly described herein, but that might be useful to refining shuttle user 116 ETA (including, but not limited to different itinerary patterns, additional typical behavior characteristics or different baggage handling situations). Further, it would be obvious to one skilled in the art that individual shuttle users 116 may have one or many of the identifying characteristics of shuttle users 116a-o as well as other relevant characteristics in any conceivable combination.

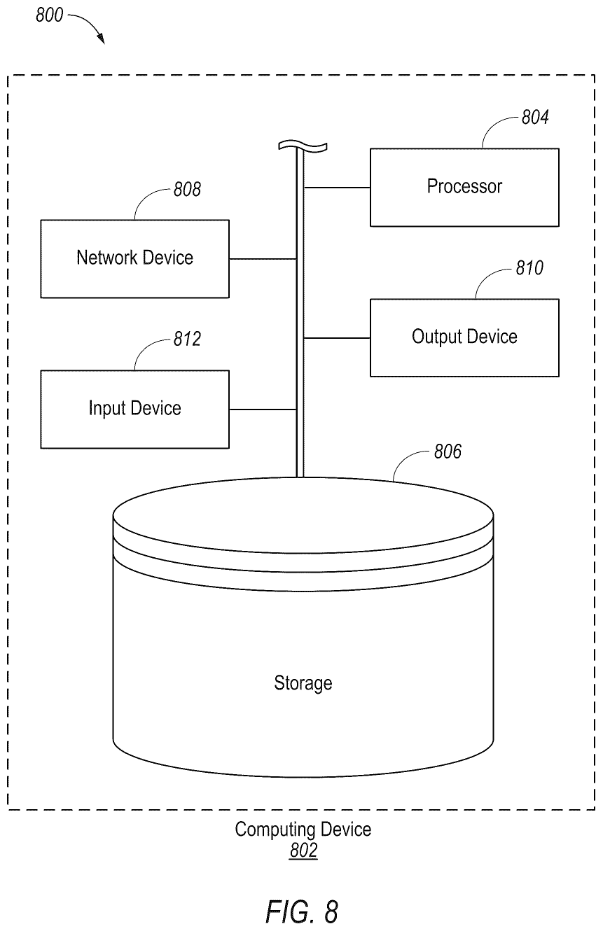

FIG. 8 illustrates an example computing device 802 for use in implementing the shuttle user pickup system 100 for consumer shuttle vehicles 102. Referring to FIG. 8, and with reference to FIGS. 1-7D, the shuttle vehicles 102, controllers 104, TCU 106, communications network 108, sensors 110, GNSS controller 112, HMI controller 114, location identification devices 118, mobile devices 122, shuttle management server 126, are examples of such computing devices 802. Computing devices 802 generally include computer-executable instructions, such as those of the shuttle management service 128 as well as processes 200 or 300, where the instructions may be executable by one or more computing devices 802. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the shuttle vehicle details 120 or shuttle user details 130 may be stored and transmitted using a variety of computer-readable media.

As shown, the computing device 802 may include a processor 804 that is operatively connected to a storage 806, a network device 808, an output device 810, and an input device 812. It should be noted that this is merely an example, and computing devices 802 with more, fewer, or different components may be used.

The processor 804 may include one or more integrated circuits that implement the functionality of a central processing unit (CPU) and/or graphics processing unit (GPU). In some examples, the processors 804 are a system on a chip (SoC) that integrates the functionality of the CPU and GPU. The SoC may optionally include other components such as, for example, the storage 806 and the network device 808 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 804 executes stored program instructions that are retrieved from the storage 806. The stored program instructions, accordingly, include software that controls the operation of the processors 804 to perform the operations described herein. The storage 806 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the shuttle user pickup system 100.

The GPU may include hardware and software for display of at least two-dimensional (2D) and optionally three-dimensional (3D) graphics to an output device 810. The output device 810 may include a graphical or visual display device, such as an electronic display screen, projector, printer, or any other suitable device that reproduces a graphical display. As another example, the output device 810 may include an audio device, such as a loudspeaker or headphone. As yet a further example, the output device 810 may include a tactile device, such as a mechanically raiseable device that may, in an example, be configured to display braille or another physical output that may be touched to provide information to a user.

The input device 812 may include any of various devices that enable the computing device 802 to receive control input from users. Examples of suitable input devices 812 that receive human interface inputs may include keyboards, mice, trackballs, touchscreens, microphones, graphics tablets, and the like.

The network devices 808 may each include any of various devices that enable the described components to send and/or receive data from external devices over networks. Examples of suitable network devices 808 include an Ethernet interface, a Wi-Fi transceiver, a cellular transceiver, or a BLUETOOTH or Bluetooth Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for enhanced shuttle pickup management comprising:
sending shuttle user details about a plurality of shuttle users to a shuttle pickup management server, wherein the shuttle user details are relevant to movement via shuttle vehicles of the shuttle users to their next destination and include at least one of: an estimated time of arrival (ETA) of the plurality of the shuttle users at a designated pickup area, a plurality of details regarding luggage of the plurality of users, an itinerary of the plurality of the shuttle users, or a location of vehicles of the shuttle users;
executing a machine learning optimization algorithm by a shuttle management pickup server to optimize at least one characteristic based on the details about the plurality of shuttle users, wherein the characteristic reflects shuttle fleet key performance indicators; and
deploying at least one shuttle vehicle of a plurality of shuttle vehicles to the designated pickup area based on the machine learning optimization algorithm, such that shuttle deployment optimizes the at least one characteristic.

2. The method of claim 1, wherein an ETA of the shuttle users is based on at least one of:
an itinerary of the shuttle users;
a typical behavior of the shuttle users;
a location of the shuttle users enroute to the designated pickup area of the shuttle users based on at least one location identification device; or
the shuttle users checked luggage status.

3. The method of claim 2, wherein the at least one location identification device is one of:
a stationary video camera,
a Wi-Fi access point,
a mobile device,
a vehicle sensor, or
an radio frequency identification (RFID) transponder.

4. The method of claim 1, wherein the at least one characteristic includes at least one of:
a wait time for the plurality of shuttle users;
a likelihood that at least one of the plurality of shuttle users will be able to make a time-sensitive connection in his or her itinerary;
an aggregate travel time of the plurality of shuttle users; and
a cost of operations of the shuttle vehicles.

5. The method of claim 4, wherein the likelihood that at least one of the shuttle users will be able to make the connection is based on at least one of:
a time-sensitive next step in the itinerary of the plurality of the shuttle users;
real time updates from public transportation systems; or
traffic patterns on a route to the time-sensitive next step.

6. The method of claim 4, wherein the shuttle deployment optimizes at least two characteristics, and the at least two characteristics are weighted based on a dynamically assessed relative value.

7. The method of claim 1, wherein locations of the vehicles of the shuttle users are previously recorded parked vehicle locations of the vehicles of the shuttle users.

8. The method of claim 7, wherein the vehicles of the shuttle users are partially autonomous, and the parked vehicle locations includes a predefined staging area to which a plurality of the vehicles of the shuttle users have redeployed.

9. The method of claim 1, wherein the details regarding the luggage of the plurality of users include at least one of:
a dimension of the luggage;
a weight of the luggage; or
a special handling characteristic of the luggage.

10. The method of claim 9, wherein the special handling characteristic is at least one of:
that the luggage is designated as fragile;
that the luggage requires climate control; or
that the luggage requires specialized equipment for loading.

11. The method of claim 1, wherein the designated pickup area is determined by at least one of:
traffic patterns in around a vehicle traffic/parking area;
detected vehicles parked in potential designated pickup areas;
a size of the shuttle vehicle compared to available parking in the potential designated pickup areas; or
a pre-assignment of the designated pickup area.

12. The method of claim 11, wherein the designated pickup area is sent to an application on a mobile device belonging to at least one of the plurality of the shuttle users.

13. The method of claim 1, wherein at least one of the plurality of users requires a special accommodation, the at least one of the plurality of shuttles provides the special accommodation and the at least one of the plurality of shuttle is deployed to accommodate the special accommodation.

14. The method of claim 13, wherein the special accommodation is at least one of:
an ability to transport a user in a wheelchair;
special equipment designed to support blind shuttle users;
car seats for shuttle users with young children; or
special office equipment for workers who need to conduct a video teleconference en route to their next destination.

15. A system for enhanced shuttle pickup management comprising:
a storage configured to maintain shuttle vehicle details about a plurality of shuttle vehicles and shuttle user details about a plurality of shuttle users including at least an identified location of the plurality of shuttle users enroute to a designated pickup area;
wherein the shuttle vehicle details and the shuttle user details are relevant to movement via shuttle vehicle of the shuttle users to their next destination;
at least one location identification device configured to identify the location of the plurality of shuttle users;
a shuttle pickup management server configured to execute a machine learning optimization algorithm to optimize at least one characteristic, using the shuttle vehicle details and the shuttle user details, deploy at least one of the plurality of shuttle vehicles, calculate a shuttle estimated time of arrival (ETA), and calculate a designated shuttle pickup location, wherein the characteristic reflects shuttle fleet key performance indicators; and
an application on a shuttle user mobile device configured to display the shuttle ETA and the designated shuttle pickup location of at least one of the plurality of shuttle users.

16. The system of claim 15, wherein the at least one location identification device is one of:
a stationary video camera;
a Wi-Fi access point;
a mobile device;
a vehicle sensor; or
an RFID transponder.

17. The system of claim 15, wherein the shuttle vehicle details include at least one of:
a passenger capacity of each of the plurality of shuttle vehicles;
a cargo capacity of each of the plurality of shuttle vehicles;
a current capacity utilization of the plurality of shuttle vehicles;
a current repair status of the plurality of shuttle vehicles;
a current location of each of the plurality of shuttle vehicles;
a current assigned task of each of the plurality of shuttle vehicles; or
an ability to transport a user in a wheelchair of each of the plurality of shuttle vehicles.

18. The system of claim 15, wherein the shuttle user details about the plurality of shuttle users also includes at least one of:
an itinerary of the plurality of shuttle users;
a location of vehicles of the plurality of shuttle users;
a party size of the plurality of shuttle users;
typical behaviors of the plurality of shuttle users;
a dimension of pieces of luggage of the plurality of shuttle users;
a weight of pieces of luggage of the plurality of shuttle users; or
a special handling characteristic of pieces of luggage of the plurality of shuttle users.

19. The system of claim 15, wherein the at least one characteristic at includes one of:
a wait time for the plurality of shuttle users;
a likelihood that at least one shuttle user of the plurality of shuttle users will be able to make a time-sensitive connection in an itinerary of the at least one shuttle user;
an aggregate travel time of the plurality of shuttle users; and
a cost of operations of the plurality of shuttle vehicles.

20. The system of claim 19, wherein the likelihood that at least one of the plurality of shuttle users will be able to make the time-sensitive connection in the itinerary is based on at least one of:
current time;
a required arrival time to make the time-sensitive connection;
real time updates from public transportation systems; and
traffic patterns on a route to the time-sensitive connection.

21. The system of claim 15, wherein the designated pickup area is determined by at least one of:
traffic patterns in around a vehicle traffic/parking area;
detected vehicles parked in potential designated pickup areas;
a size of the shuttle vehicle compared to available parking in the potential designated pickup areas; or
a pre-assignment of the designated pickup area.

22. The system of claim 15, wherein at least one of the plurality of shuttle vehicles is fully autonomous.

23. The system of claim 15, wherein the storage is further configured to maintain weather details relevant to movement via shuttle vehicle of the shuttle users to their next destination and the shuttle pickup management server is further configured to use weather details in addition to the shuttle vehicle details and shuttle user details to optimize the at least one characteristic, calculate the shuttle ETA and the designated shuttle pickup location; and
wherein the weather details include at least one of:
precipitation;
temperature;
wind conditions; and
humidity.

24. A non-transitory computer-readable medium comprising instructions for shuttle pickup management that, when executed by a shuttle pickup management server, cause the shuttle pickup management server to perform operations including to:
maintain shuttle vehicle details about a plurality of shuttle vehicles, shuttle user details about a plurality of shuttle users, and weather details, wherein the shuttle vehicle details, shuttle user details, and weather details are relevant to movement via shuttle vehicle of the shuttle users to their next destination;
wherein the shuttle vehicle details include at least one of:
a passenger capacity of each of the plurality of shuttle vehicles;
a cargo capacity of each of the plurality of shuttle vehicles;
a current capacity utilization of the plurality of shuttle vehicles;
a current repair status of the plurality of shuttle vehicles;
a current location of each of the plurality of shuttle vehicles;
a current assigned task of each of the plurality of shuttle vehicles; or
an ability to transport a user in a wheelchair of each of the plurality of shuttle vehicles,
wherein the shuttle user details include at least one of:
an itinerary of the plurality of shuttle users;
a location of vehicles of the plurality of shuttle users;
a party size of the plurality of shuttle users;
typical behaviors of the plurality of shuttle users;
a dimension of pieces of luggage of the plurality of shuttle users;
a weight of pieces of luggage of the plurality of shuttle users;
a special handling characteristic of luggage of the plurality of shuttle users; or
a location of the plurality of shuttle users identified by at least one location identification device configured to identify shuttle user location,
wherein the at least one location identification device is one of:
a stationary video camera,
a Wi-Fi access point,
a mobile device,
a vehicle sensor, or
an RFID transponder;
execute a machine learning optimization algorithm using the shuttle vehicle details, the shuttle user details, and the weather details to optimize at least one characteristic based on the details about the plurality of shuttle users, wherein the at least one characteristic reflects shuttle fleet key performance indicators;
including at least at least one of:
a wait time for the plurality of shuttle users;
a likelihood that at least one of the plurality of shuttle users will be able to make a time-sensitive connection in his or her itinerary;
an aggregate travel time of the plurality of shuttle users; and
a cost of operations of the shuttle fleet;
deploy at least one of a plurality of shuttle vehicles according to the machine learning optimization algorithm,
calculate a shuttle estimated time of arrival (ETA) and a designated shuttle pickup location, and
send the shuttle ETA and the designated shuttle pickup location of at least one of the plurality of shuttle users to an application on a shuttle user mobile device.
